(19) United States
(12) Patent Application Publication
(10) Pub. No.: US 2010/0255887 A1
(43) Pub. Date: Oct. 7, 2010

(54) MOBILE TERMINAL AND METHOD OF PROVIDING RECOMMENDED MUSIC USING THE SAME

(76) Inventors: Hyung Nam LEE, Seoul (KR); Uni Young KIM, Seoul (KR); Jae Hee SHIM, Seoul (KR); Sae Hun JANG, Seoul (KR); Kyung Hee YOO, Seoul (KR); II Hea KIM, Seoul (KR)

Correspondence Address: BIRCH STEWART KOLASCH & BIRCH, PO BOX 747, FALLS CHURCH, VA, 22040-0747, US

(21) Appl. No.: 12/750,863

(22) Filed: Mar. 31, 2010

(30) Foreign Application Priority Data
Apr. 1, 2009 (KR) 10-2009-0028139

(51) Int. Cl. H04B 1/38; G06F 17/00; G09G 5/00

(52) U.S. Cl. 455/566; 700/94; 345/581

(57) ABSTRACT

A mobile terminal and a method of providing recommended music using the same are provided. The method of providing recommended music in a mobile terminal includes the steps of displaying a plurality of objects respectively corresponding to at least one recommended music file and different liquid attributes; selecting one of the plurality of objects; dynamically displaying the selected object to reflect the liquid attribute corresponding to the selected object; and outputting recommended music corresponding to the selected object.

### BACKGROUND OF THE INVENTION

1. Field of the Invention

The present invention relates to a mobile terminal, and more particularly, to a mobile terminal and a method of providing recommended music using the same for introducing a new graphical element in providing recommended music to allow a user to have a new visual experience and enjoy the experience.

2. Discussion of the Related Art

Many conventional mobile terminals have a function of playing music files. Further, conventional mobile terminals provide a function of recommending music to users. However, graphical elements provided by the music playing function of the conventional mobile terminals are too simple, and thus users are difficult to enjoy them. Furthermore, since the music recommendation function of the conventional mobile terminals is difficult to use, users cannot feel sympathy for recommended music or do not frequently use the music recommendation function.

### SUMMARY OF THE INVENTION

Accordingly, one object of the present invention is to address the above-noted and other drawbacks of the related art.

Another object of the present invention is to provide a mobile terminal and a method of providing recommended music using the same for introducing a graphical element having a liquid attribute in providing recommended music to allow a user to have a new experience and enjoy the experience.

Still another object of the present invention is to provide a mobile terminal and a method of providing recommended music using the same for allowing a user to easily know the genre of recommended music through a graphic.

To accomplish the objects of the present invention, according to an aspect of the present invention, there is provided a method of providing recommended music in a mobile terminal, which includes the steps of displaying a plurality of objects respectively corresponding to at least one recommended music file and different liquid attributes; selecting one of the plurality of objects; dynamically displaying the selected object to reflect the liquid attribute corresponding to the selected object; and outputting recommended music corresponding to the selected object.

To accomplish the objects of the present invention, according to another aspect of the present invention, there is provided a mobile terminal including a display unit; a memory configured to store at least one music file and a plurality of objects respectively corresponding to at least one recommended music piece belonging to the at least one music file and different liquid attributes; and a controller configured to display the plurality of objects on the display unit, dynamically display an object selected from the plurality of objects to reflect the liquid attribute corresponding to the selected object and output recommended music corresponding to the selected object.

According to the mobile terminal and a method of providing recommended music using the same according to the present invention, a graphical element having a liquid attribute and recommended music are combined to allow a user to have a new visual experience and enjoy the experience.

Furthermore, the user can be easily aware of the genre of recommended music through a new graphical element and provided with recommended music in a desired genre.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to an embodiment of the present invention;

FIG. 2A is a front perspective view of a handheld terminal according to an embodiment of the present invention;

FIG. 2B is a rear perspective view of the handheld terminal shown in FIG. 2A;

FIGS. 3A and 3B are front views of the handheld terminal and are used for explaining an operating state of the handheld terminal according to an embodiment of the present invention;

FIG. 4 is a conceptional view for explaining a proximity depth of a proximity sensor;

FIG. 5 shows a configuration of a CDMA wireless communication system which communicates with the mobile terminal 100 shown in FIG. 1;

FIG. 6 is a flowchart of a method of providing recommended music in a mobile terminal according to an embodiment of the present invention;

FIG. 7 shows an example of a screen displaying an image of an activated music playing application;

FIGS. 8 and 9 show exemplary images displayed when step S100 shown in FIG. 6 is performed;

FIG. 10 shows an exemplary image displayed when step S130 shown in FIG. 6 is performed;

FIGS. 11A, 11B and 11C show another exemplary images displayed when step S130 shown in FIG. 6 is performed; and

FIGS. 12A, 12B, 12C and 12D show exemplary images of an object, which are dynamically displayed in connection with a motion of the mobile terminal according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

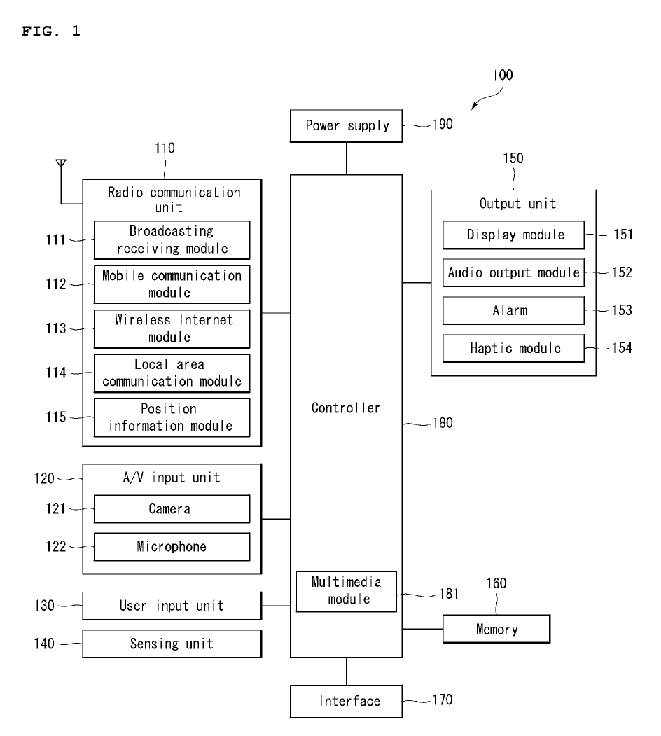

FIG. 1 is a block diagram of a mobile terminal 100 according to an embodiment of the present invention. As shown, the mobile terminal 100 includes a radio communication unit 110, an audio/video (A/V) input unit 120, a user input unit 130, a sensing unit 140, an output unit 150, a memory 160, an interface 170, a controller 180, and a power supply 190.

In addition, the radio communication unit 110 includes at least one module that enables radio communication between the mobile terminal 100 and a radio communication system or between the mobile terminal 100 and a network in which the mobile terminal 100 is located. For example, the radio communication unit 110 includes a broadcasting receiving module 111, a mobile communication module 112, a wireless Internet module 113, a local area communication module 114 and a position information module 115.

The broadcasting receiving module 111 receives broadcasting signals and/or broadcasting related information from an external broadcasting management server through a broadcasting channel. Also, the broadcasting channel can include a satellite channel and a terrestrial channel, and the broadcasting management server can be a server that generates and transmits broadcasting signals and/or broadcasting related information or a server that receives previously created broadcasting signals and/or broadcasting related information and transmits the broadcasting signals and/or broadcasting related information to a terminal.

Further, the broadcasting signals can include not only TV broadcasting signals, radio broadcasting signals and data broadcasting signals, but also signals in the form of combination of a TV broadcasting signal and a radio broadcasting signal. In addition, the broadcasting related information can be information on a broadcasting channel, a broadcasting program or a broadcasting service provider, and can be provided even through a mobile communication network. In the latter case, the broadcasting related information can be received by the mobile communication module 112.

Also, the broadcasting related information can exist in various forms. For example, the broadcasting related information can exist in the form of an electronic program guide (EPG) of the digital multimedia broadcasting (DMB) system or in the form of an electronic service guide (ESG) of the digital video broadcast-handheld (DVB-H) system.

In addition, the broadcasting receiving module 111 receives broadcasting signals using various broadcasting systems. Particularly, the broadcasting receiving module 111 can receive digital broadcasting signals using digital broadcasting systems such as the digital multimedia broadcasting-terrestrial (DMB-T) system, the digital multimedia broadcasting-satellite (DMB-S) system, the media forward link only (MediaFLO) system, the DVB-H and integrated services digital broadcast-terrestrial (ISDB-T) systems, etc. The broadcasting receiving module 111 can also be constructed to be suited to broadcasting systems providing broadcasting signals other than the above-described digital broadcasting systems.

Further, the broadcasting signals and/or broadcasting related information received through the broadcasting receiving module 111 can be stored in the memory 160. The mobile communication module 112 transmits/receives a radio signal to/from at least one of a base station, an external terminal and a server on a mobile communication network. The radio signal can include a voice call signal, a video telephony call signal or data in various forms according to transmission and reception of text/multimedia messages.

In addition, the wireless Internet module 113 corresponds to a module for wireless Internet access and can be included in the mobile terminal 100 or externally attached to the mobile terminal 100. A wireless LAN (WLAN) (Wi-Fi), wireless broadband (Wibro), world interoperability for microwave access (Wimax), high speed downlink packet access (HSDPA) and so on can be used as a wireless Internet technique.

Also, the local area communication module 114 corresponds to a module for local area communication. Further, bluetooth, radio frequency identification (RFID), infrared data association (IrDA), ultra wideband (UWB) and ZigBee can be used as a local area communication technique.

The position information module 115 confirms or obtains the position of the mobile terminal. In more detail, a global positioning system (GPS) module is a representative example of the position information module 115. In addition, the GPS module 115 can calculate information on distances between one point or object and at least three satellites and information on the time when the distance information is measured and apply trigonometry to the obtained distance information to obtain three-dimensional position information on the point or object according to the latitude, longitude and altitude at a predetermined time.

Furthermore, a method of calculating position and time information using three satellites and correcting the calculated position and time information using another satellite can also used. In addition, the GPS module 115 continuously calculates the current position in real time and calculates velocity information using the position information.

Referring to FIG. 1, the A/V input unit 120 is used to input an audio signal or a video signal and includes a camera 121 and a microphone 122. The camera 121 processes image frames of still images or moving images obtained by an image sensor in a video telephony mode or a photographing mode. Further, the processed image frames can be displayed on a display unit 151.

Also, the image frames processed by the camera 121 can be stored in the memory 160 or transmitted to an external device through the radio communication unit 110. The mobile terminal 100 can also include at least two cameras. The microphone 122 receives an external audio signal in a call mode, a recording mode or a speed recognition mode and processes the received audio signal into electric audio data.

The audio data can then be converted into a form that can be transmitted to a mobile communication base station through the mobile communication module 112 and output in the call mode. Further, the microphone 122 can employ various noise removal algorithms for removing noise generated when the external audio signal is received.

In addition, the user input unit 130 receives input data for controlling the operation of the terminal from a user. The user input unit 130 can include a keypad, a dome switch, a touch pad (constant voltage/capacitance), jog wheel, jog switch and so on.

Also, the sensing unit 140 senses the current state of the mobile terminal 100, such as an open/close state of the mobile terminal 100, the position of the mobile terminal 100, whether a user touches the mobile terminal 100, the direction of the mobile terminal 100 and the acceleration/deceleration of the mobile terminal 100, and generates a sensing signal for controlling the operation of the mobile terminal 100.

For example, the sensing unit 140 can sense whether a slide phone is opened or closed when the mobile terminal 100 is the slide phone. Furthermore, the sensing unit 140 can sense whether the power supply 190 supplies power and whether the interface 170 is connected to an external device. The sensing unit 140 can also include a proximity sensor.

In addition, the output unit 150 generates visual, auditory or tactile output and can include the display unit 151, an audio output module 152, an alarm 153 and a haptic module 154. Further, the display unit 151 displays information processed by the mobile terminal 100. For example, the display unit 151 displays a user interface (UI) or graphic user interface (GUI) related to a telephone call when the mobile terminal is in the call mode. The display unit 151 also displays a captured or/and received image, UI or GUI when the mobile terminal 100 is in the video telephony mode or the photographing mode.

In addition, the display unit 151 can include at least one of a liquid crystal display, a thin film transistor liquid crystal display, an organic light-emitting diode display, a flexible display and a three-dimensional display. Further, some of these displays can be of a transparent type or a light transmission type. That is, the display unit 151 can include a transparent display.

In more detail, the transparent display includes a transparent liquid crystal display. Further, the rear structure of the display unit 151 can also be of the light transmission type. Accordingly, a user can see an object located behind the body of the mobile terminal 100 through the transparent area of the body of the mobile terminal 100, which is occupied by the display unit 151.

The mobile terminal 100 can also include at least two display units 151. For example, the mobile terminal 100 can include a plurality of displays that are arranged on a single face at a predetermined distance or integrated displays. The plurality of displays can also be arranged on different sides.

In addition, when the display unit 151 and a sensor sensing touch (referred to as a touch sensor hereinafter) form a layered structure, which is referred to as a touch screen hereinafter, the display unit 151 can be used as an input device in addition to an output device. The touch sensor can be in the form of a touch film, a touch sheet and a touch pad, for example.

Further, the touch sensor can be constructed to convert a variation in pressure applied to a specific portion of the display unit 151 or a variation in capacitance generated at a specific portion of the display unit 151 into an electric input signal. The touch sensor can also be constructed to sense pressure of touch as well as the position and area of the touch.

Also, when the user applies touch input to the touch sensor, a signal corresponding to the touch input is transmitted to a touch controller. The touch controller then processes the signal and transmits data corresponding to the processed signal to the controller 180. Accordingly, the controller 180 can detect a touched portion of the display 151.

Referring to FIG. 1, the proximity sensor of the sensing unit 140 can be located in an internal region of the mobile terminal, surrounded by the touch screen, or near the touch screen. The proximity sensor senses an object approaching a predetermined sensing face or an object located near the proximity sensor using an electromagnetic force or infrared rays without having mechanical contact. Further, the proximity sensor has lifetime longer than that of a contact sensor and thus has a wide application in the mobile terminal 100.

In addition, the proximity sensor includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, etc. Further, a capacitive touch screen is constructed such that proximity of a pointer is detected through a variation in an electric field according to the proximity of the pointer. In this instance, the touch screen (touch sensor) can be classified as a proximity sensor.

For convenience of explanation, the action of the pointer approaching the touch screen without actually touching the touch screen is referred to as “proximity touch” and an action of bringing the pointer into contact with the touch screen is referred to as “contact touch” in the following description. In addition, the proximity touch point of the pointer on the touch screen corresponds to a point of the touch screen to which the pointer touches the touch screen.

Further, the proximity sensor senses the proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can then be displayed on the touch screen.

Also, the audio output module 152 can output audio data received from the radio communication unit 110 or stored in the memory 160 in a call signal receiving mode, a telephone call mode or a recording mode, a speech recognition mode and a broadcasting receiving mode. Further, the audio output module 152 outputs audio signals related to functions (for example, a call signal incoming tone, a message incoming tone, etc.) performed in the mobile terminal 100. The audio output module 152 can include a receiver, a speaker, a buzzer, etc.

In addition, the alarm 153 outputs a signal for indicating the generation of an event of the mobile terminal 100. For example, alarms can be generated when receiving a call signal, receiving a message, inputting a key signal, inputting touch, etc. The alarm 153 can also output signals in forms different from video signals or audio signals, for example, a signal for indicating generation of an event through vibration. The video signals or the audio signals can be also output through the display unit 151 or the audio output module 152.

Also, the haptic module 154 generates various haptic effects that the user can feel. One representative example of the haptic effects is vibration. The intensity and pattern of vibration generated by the haptic module 154 can also be controlled. For example, different vibrations can be combined and output or can be sequentially output.

Further, the haptic module 154 can generate a variety of haptic effects including an effect of stimulus according to arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 can also not only transmit haptic effects through direct contact but also allow the user to feel haptic effects through a kinesthetic sense of the user's fingers or arms. The mobile terminal 100 can also include multiple haptic modules 154.

In addition, the memory 160 can store a program for the operation of the controller 180 and temporarily store input/output data (for example, phone book, messages, still images, moving images, etc.). The memory 160 can also store data about vibrations and sounds in various patterns, which are output from when a touch input is applied to the touch screen.

Further, the memory 160 can include at least one of a flash memory, a hard disk type memory, a multimedia card micro type memory, a card type memory (for example, SD or XD memory), a random access memory (RAM), a static RAM (SRAM), a read-only memory (ROM), an electrically erasable programmable ROM (EEPROM), a programmable ROM (PROM) magnetic memory, a magnetic disk and an optical disk. The mobile terminal 100 can also operate in relation to a web storage performing the storing function of the memory 160 on the Internet.

The interface 170 serves as a path to external devices connected to the mobile terminal 100. Further, the interface 170 receives data from the external devices or power and transmits the data or power to the internal components of the mobile terminal 100 or transmits data of the mobile terminal 100 to the external devices. Also, the interface 170 can include a wired/wireless headset port, an external charger port, a wired/wireless data port, a memory card port, a port for connecting a device having a user identification module, an audio I/O port, a video I/O port, an earphone port, etc., for example.

In addition, the interface 170 can also interface with a user identification module that is a chip that stores information for authenticating the authority to use the mobile terminal 100. For example, the user identification module can be a user identify module (UIM), a subscriber identify module (SIM) and a universal subscriber identify module (USIM). An identification device including the user identification module can also be manufactured in the form of a smart card. Accordingly, the identification device can be connected to the mobile terminal 100 through a port of the interface 170.

The interface 170 can also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle can be used as signals for confirming whether the mobile terminal is correctly set in the cradle.

In addition, the controller 180 controls the overall operations of the mobile terminal. For example, the controller 180 performs control and processing for voice communication, data communication and video telephony. As shown in FIG. 1, the controller 180 also includes a multimedia module 181 for playing multimedia. Also, the multimedia module 181 can be included in the controller 180 as shown in FIG. 1 or can be separated from the controller 180.

Further, the controller 180 can perform a pattern recognition process capable of recognizing handwriting input or picture-drawing input applied to the touch screen as characters or images. In addition, the power supply 190 receives external power and internal power and provides power required for the operations of the components of the mobile terminal under the control of the controller 180.

Embodiments of the present invention can be implemented in a computer or similar device readable recording medium by using software, hardware or a combination thereof, for example.

According to hardware implementation, the embodiments of the present invention can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units for executing functions. In some cases, the embodiments can be implemented by the controller 180.

According to software implementation, embodiments such as procedures or functions can be implemented with a separate software module executing at least one function or operation. Software codes can be implemented according to a software application written in an appropriate software language. Furthermore, the software codes can be stored in the memory 160 and executed by the controller 180.

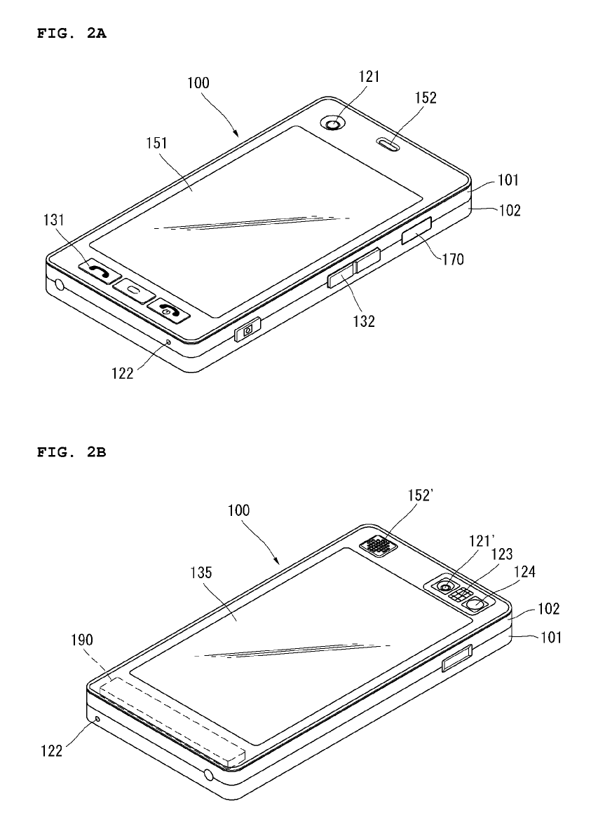

Next, FIG. 2A is a front perspective view of a mobile terminal or a handheld terminal 100 according to an embodiment of the present invention. In this example, the handheld terminal 100 is a bar type terminal body. However, the present invention is not limited to a bar type terminal and can be applied to terminals of various types including slide type, folder type, swing type and swivel type terminals.

In addition, the terminal body includes a case (a casing, a housing, a cover, etc.) forming the exterior of the terminal 100. In the present embodiment, the case is divided into a front case 101 and a rear case 102. Further, various electronic components are arranged in the space formed between the front case 101 and the rear case 102. At least one middle case can also be additionally arranged between the front case 101 and the rear case 102. Also, the cases can be formed of plastics through injection molding or made of a metal material such as stainless steel (STS) or titanium (Ti).

As shown in FIG. 2A, the display unit 151, the audio output unit 152, the camera 121, user input units 131 and 132, the microphone 122 and the interface 170 are arranged in the terminal body, specifically, in the front case 101. In addition, the display unit 151 occupies most of the main face of the front case 101.

Further, the audio output unit 152 and the camera 121 are arranged in a region in proximity to one of both ends of the display unit 151. Also, the user input unit 131 and the microphone 122 are located in a region in proximity to the other end of the display unit 151. Also include is another user input unit 132, which is arranged with the interface 170 on the sides of the front case 101 and the rear case 102.

Thus, in this embodiment, the user input unit 130 includes multiple operating units 131 and 132 that are operated to receive commands for controlling the operation of the handheld terminal 100. Further, the operating units 131 and 132 can be referred to as manipulating portions and employ any tactile manner in which a user operates the operating units 131 and 132 while producing a tactile feeling.

Also, the operating units 131 and 132 can receive various inputs. For example, the operating unit 131 receives commands such as start and end a call, and the operating unit 132 receives commands such as to control the volume of the sound output from the audio output unit 152 or to convert the display unit 151 into a touch recognition mode.

Next, FIG. 2B is a rear perspective view of the handheld terminal shown in FIG. 2A according to an embodiment of the present invention. As shown in FIG. 2B, a camera 121′ is additionally attached to the rear side of the terminal body, that is, the rear case 102. In this configuration, the camera 121′ has a photographing direction that is opposite to that of the camera 121 shown in FIG. 2a and can have pixels different from those of the camera 121 shown in FIG. 2A.

For example, in one example, it is preferable that the camera 121 has low pixels such that it can capture an image of the face of a user and transmit the image to a receiving part during video telephony while the camera 121′ has high pixels such that it can capture an image of a general object and does not immediately transmit the image in many situations. The cameras 121 and 121′ can also be attached to the terminal body such that they can be rotated or popped-up.

As shown in FIG. 2B, a flash bulb 123 and a mirror 124 are additionally arranged in proximity to the camera 121′. The flash bulb 123 lights an object when the camera 121′ takes a picture of the object, and the mirror 124 is used for the user to look at his or her face when the user wants to take a picture of themselves using the camera 121′.

An audio output unit 152′ is also additionally provided on the rear side of the terminal body. In this embodiment, the audio output unit 152′ can achieve a stereo function with the audio output unit 152 shown in FIG. 2A and be used in a speaker phone mode when the terminal is used for a telephone call.

A broadcasting signal receiving antenna can also be additionally attached to a side of the terminal body in addition to an antenna for telephone calls. The antenna forming a part of the broadcasting receiving module 111 shown in FIG. 1 can be set in the terminal body such that the antenna can be pulled out of the terminal body.

In addition, the power supply 190 for providing power to the handheld terminal 100 is set in the terminal body, and can be included in the terminal body or detachably attached to the terminal body. FIG. 2B also illustrates a touch pad 135 for sensing touch additionally attached to the rear case 102 of the terminal 100. Further, the touch pad 135 can be a light transmission type as the display module 151. In this instance, when the display module 151 outputs visual information through both sides, the visual information can be recognized through the touch pad 135.

Also, the information output through both sides of the display module 151 can be controlled by the touch pad 135. In addition, a display can be additionally attached to the touch pad 135 such that a touch screen can be arranged even in the rear case 102. Further, the touch pad 135 operates in connection with the display module 151 of the front case 101, and can be located in parallel with the display module 151 behind the display module 151. The touch panel 135 can also be identical to or smaller than the display unit 151 in size.

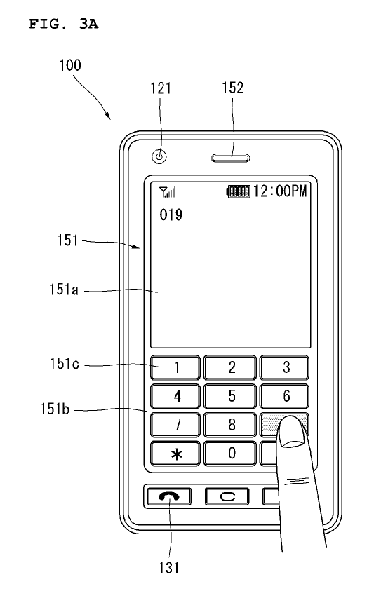

The interoperations of the display unit 151 and the touch pad 135 will now be described with reference to FIGS. 3A and 3B. In more detail, FIGS. 3A and 3B are front views of the handheld terminal 100 and are used for explaining an operating state of the handheld terminal according to an embodiment of the present invention.

The display module 151 can display various types of visual information in the form of characters, numerals, symbols, graphic or icons. To input the information, at least one of the characters, numerals, symbols, graphic and icons are displayed in predetermined arrangement in the form of a keypad. Also, the keypad can be referred to as a ‘soft key’.

Further, FIG. 3A shows that touch applied to a soft key is input through the front side of the terminal body. The display module 151 can be a single area or can be divided into a plurality of regions. In the latter instance, the display unit 151 is constructed such that the plurality of regions interoperate with each other.

For example, and as shown in FIG. 3A, an output region 151a and an input region 151b are respectively displayed in upper and lower parts of the display module 151. The input region 151b displays soft keys 151c that represent numerals used to input numbers such as telephone numbers. Thus, when a soft key 151c is touched, a numeral corresponding to the touched soft key is displayed on the output region 151a. Further, when the user operates the first operating unit 116, a connection of a call corresponding to a telephone number displayed on the output region 151a is attempted.

Next, FIG. 3B is an overview of the mobile terminal 100 showing that touch applied to soft keys is input through the rear side of the terminal body. FIG. 3B also shows the landscape of the terminal body while FIG. 3A shows the portrait of the terminal body. In addition, the display unit 151 is constructed such that an output image is converted according to the direction in which the terminal body is located.

Further, FIG. 3B shows the operation of the handheld terminal in a text input mode. As shown, the display unit 151 includes a touch pad display 135 having an output region 135a and an input region 135b. A plurality of soft keys 135c indicating at least one of characters, symbols and numerals are also arranged in the input region 135b. Further, in this embodiment, the soft keys 135c are arranged in the form of QWERTY keys.

Thus, when the soft keys 135c are touched through the touch pad 135, the characters, numerals and symbols corresponding to the touched soft keys 135c are displayed on the output region 135a. Touch input through the touch pad 135 can prevent the soft keys 135c from being covered with user's fingers when the soft keys 135c are touched as compared to touch input through the display unit 151. Further, when the display unit 151 and the touch pad 135 are transparent, the user can see his or her fingers located behind the terminal body, and thus can select items by touching the backside or surface of the displayed keys 135c.

In addition, the user can scroll the display unit 151 or the touch pad 135 to move an object displayed on the display unit 151, for example, by using a cursor or a pointer located on an icon. Also, when the user moves his or her finger on the display unit 151 or the touch pad 135, the controller 180 can visually display the user's finger moving path on the display unit 151. This is useful to edit an image displayed on the display unit 151.

Also, when the display unit 151 (touch screen) and the touch pad 135 are simultaneously touched within a predetermined period of time, a specific function of the terminal can be executed. For example, the user can clamp the terminal body using their thumb and index finger. This specific function can include activating or deactivating the display unit 151 or the touch pad 135, for example.

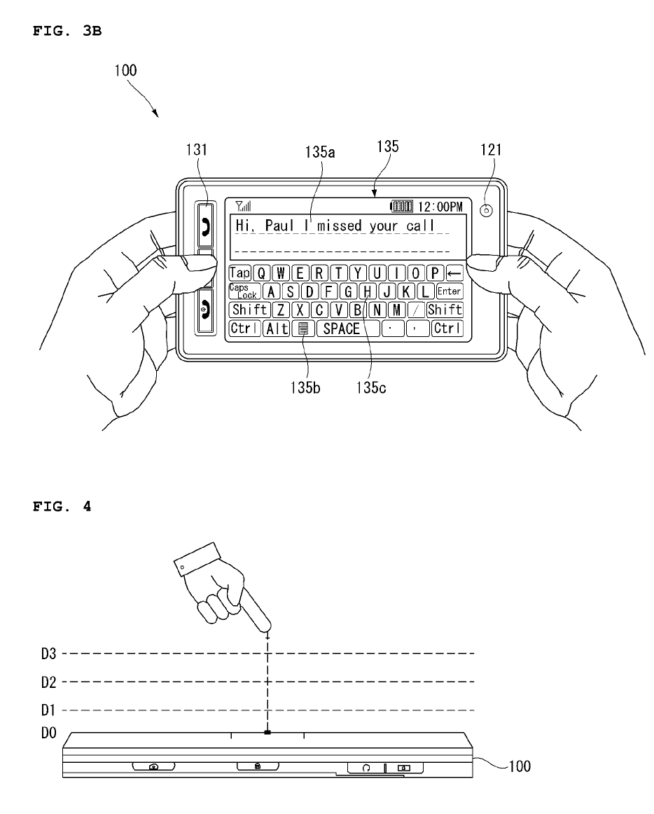

The proximity sensor described with reference to FIG. 1 will now be explained in more detail with reference to FIG. 4. That is, FIG. 4 is a conceptual diagram used for explaining a proximity depth of the proximity sensor.

As shown in FIG. 4, when a pointer such as a user's finger approaches the touch screen, the proximity sensor located inside or near the touch screen senses the approach and outputs a proximity signal. Further, the proximity sensor can be constructed such that it outputs a proximity signal according to the distance between the pointer approaching the touch screen and the touch screen (referred to as “proximity depth”).

Also, the distance in which the proximity signal is output when the pointer approaches the touch screen is referred to as a detection distance. The proximity depth can be determined using a plurality of proximity sensors having different detection distances and comparing proximity signals respectively output from the proximity sensors.

FIG. 4 shows the section of the touch screen in which proximity sensors capable of sensing three proximity depths are arranged. Of course, proximity sensors capable of sensing less than three or more than three proximity depths can be arranged in the touch screen.

Thus, as shown in FIG. 4, when the pointer (user's finger in this example) completely comes into contact with the touch screen (D0), the controller 180 recognizes this action as the contact touch. When the pointer is located within a distance D1 from the touch screen, the controller 180 recognizes this action as a proximity touch of a first proximity depth.

Similarly, when the pointer is located in a range between the distance D1 and a distance D2 from the touch screen, the controller 180 recognizes this action as a proximity touch of a second proximity depth. When the pointer is located in a range between the distance D2 and a distance D3 from the touch screen, the controller 180 recognizes this action a proximity touch of a third proximity depth. Also, when the pointer is located at longer than the distance D3 from the touch screen, the controller 180 recognizes this action as a cancellation of proximity touch.

Accordingly, the controller 180 can recognize the proximity touch as various input signals according to the proximity distance and proximity position of the pointer with respect to the touch screen and perform various operations according to the input signals.

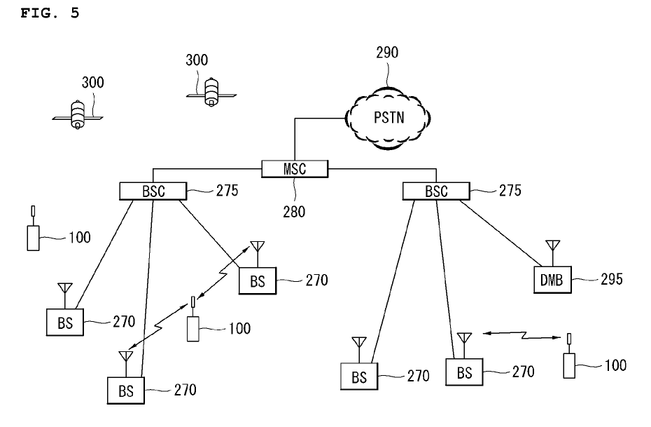

The mobile device 100 of FIG. 1 may be configured to operate within a communication system which transmits data via frames or packets, including both wireless and wireline communication systems, and satellite-based communication systems. Such communication systems utilize different air interfaces and/or physical layers. FIG. 5 is a block diagram of a CDMA wireless communication system which communicates with the mobile terminal 100 shown in FIG. 1.

Examples of such air interfaces utilized by the communication systems include frequency division multiple access (FDMA), time division multiple access (TDMA), code division multiple access (CDMA), and universal mobile telecommunications system (UMTS), the long term evolution (LTE) of the UMTS, and the global system for mobile communications (GSM). By way of non-limiting example only, further description will relate to a CDMA communication system, but such teachings apply equally to other system types.

Referring to FIG. 5, the CDMA wireless communication system is shown having a plurality of mobile terminals 100, a plurality of base stations 270, base station controllers (BSCs) 275, and a mobile switching center (MSC) 280. The MSC 280 is configured to interface with a conventional public switch telephone network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system may include more than two BSCs 275.

Each base station 270 may include one or more sectors, each sector having an omnidirectional antenna or an antenna pointed in a particular direction radially away from the base station 270. Alternatively, each sector may include two antennas for diversity reception. Each base station 270 may be configured to support a plurality of frequency assignments, with each frequency assignment having a particular spectrum (e.g., 1.25 MHz, 5 MHz).

The intersection of a sector and frequency assignment may be referred to as a CDMA channel. The base stations 270 may also be referred to as base station transceiver subsystems (STSs). In some cases, the term “base station” may be used to refer collectively to a BSC 275, and one or more base stations 270. The base stations may also be denoted “cell sites.” Alternatively, individual sectors of a given base station 270 may be referred to as cell sites.

A terrestrial digital multimedia broadcasting (DMB) transmitter 295 is shown broadcasting to the mobile devices 100 operating within the system. The broadcast receiving module 111 (FIG. 1) of the mobile terminal 100 is typically configured to receive broadcast signals transmitted by the DMB transmitter 295. Similar arrangements may be implemented for other types of broadcast and multicast signaling (as discussed above).

FIG. 5 further depicts several global positioning system (GPS) satellites 300. Such satellites 300 facilitate locating the position of some or all of the mobile terminals 100. Two satellites are depicted, but it is understood that useful positioning information may be obtained with greater or fewer satellites. It is to be appreciated that other types of position detection technology, (i.e., location technology that may be used in addition to or instead of GPS location technology) may alternatively be implemented. If desired, some or all of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and other communications. Each reverse-link signal received by a given base station 270 is processed within that base station. The resulting data is forwarded to an associated BSC 275. The BSC 275 provides call resource allocation and mobility management functionality including the orchestration of soft handoffs between base stations 270. The BSCs 275 also route the received data to the MSC 280, which provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

Embodiments of the present invention will now be explained. It is assumed that the display unit 151 is a touch screen for convenience of explanation in the specification. As described above, the touch screen 151 can perform both an information displaying function and an information input function. However, the present invention is not limited thereto.

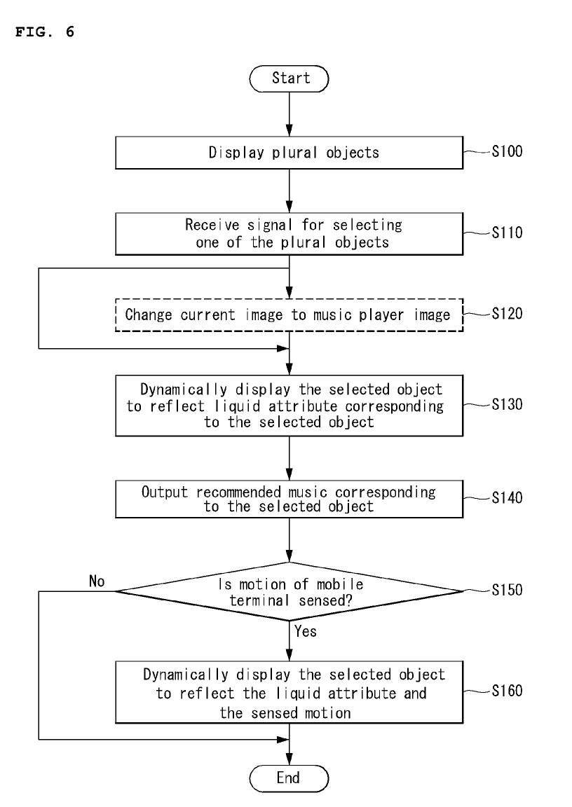

FIG. 6 is a flowchart of a method of providing recommended music in a mobile terminal according to an embodiment of the present invention. The method of providing recommended music in a mobile terminal according to an embodiment of the present invention may be implemented in the mobile terminal 100 described with reference to FIGS. 1 through 5. The method of providing recommended music in a mobile terminal and the operation of the mobile terminal 100 for implementing the method will now be explained in detail with reference to FIG. 6 and associated drawings.

The current embodiment of the present invention may be implemented in connection with a specific application provided in the mobile terminal 100. For example, the current embodiment of the present invention may be implemented in a music playing application.

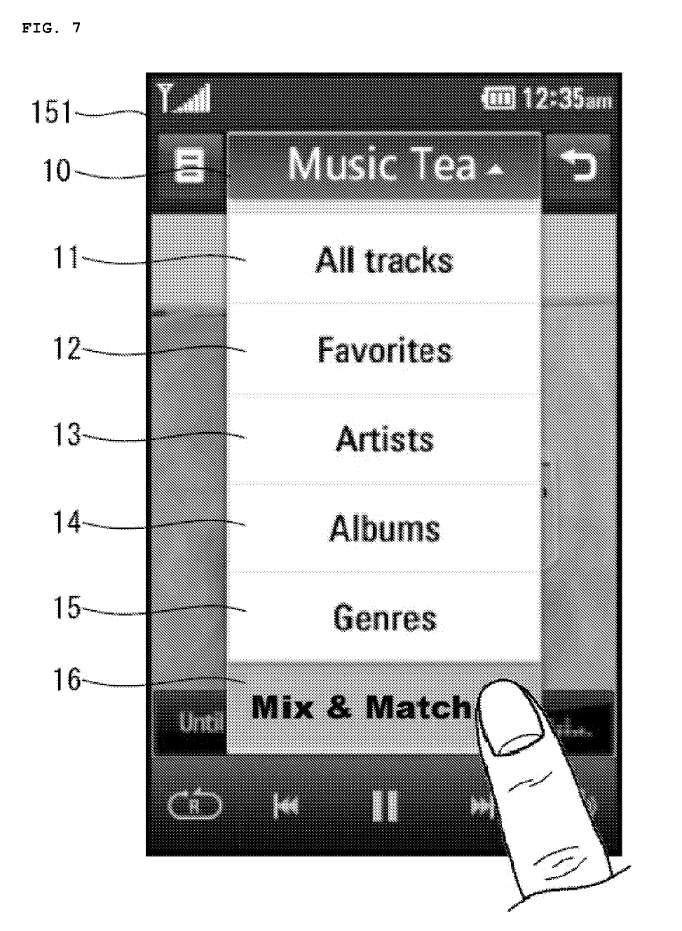

FIG. 7 shows an example of a screen displaying an image of the music playing application which is activated. Referring to FIG. 7, the music playing application may provide a menu window 10 including a plurality of menus 11, 12, 13, 14, 15 and 16.

A function of displaying a list of given music files or playing the music files is assigned to the plurality of menus 11, 12, 13, 14, 15 and 16. Specifically, the first menu 11 is assigned a function of displaying a list of all of music files managed by the music playing application or playing the music files. The second menu 12 is assigned a function of displaying a list of favorite music files of a user and playing the favorite music files. The third menu is assigned a function of displaying a list of music files corresponding to each singer and playing the music files. The fourth menu 14 is assigned a function of displaying a list of music files of each album and playing the music files. The fifth menu 15 is assigned a function of displaying a list of music files corresponding to each genre or playing the music files. The sixth menu 16 is assigned a function of displaying a list of recommended music files according to the current embodiment of the invention or playing the recommended music files.

When the controller 180 receives a signal for selecting the sixth menu 16 from the user, the controller 180 displays a plurality of objects corresponding to at least one recommended music file and different liquid attributes on the display unit 151 in step S100.

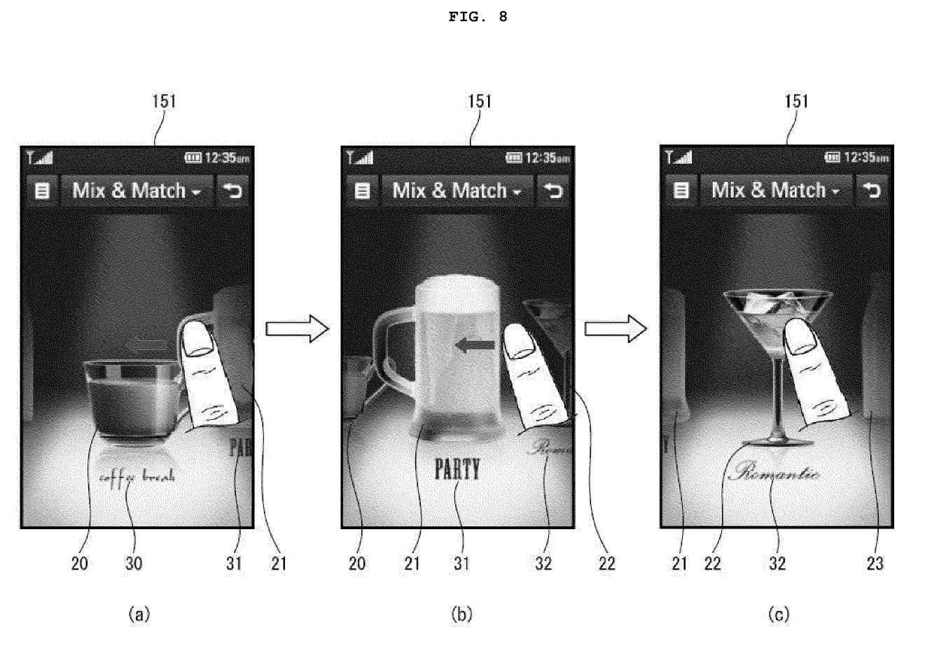

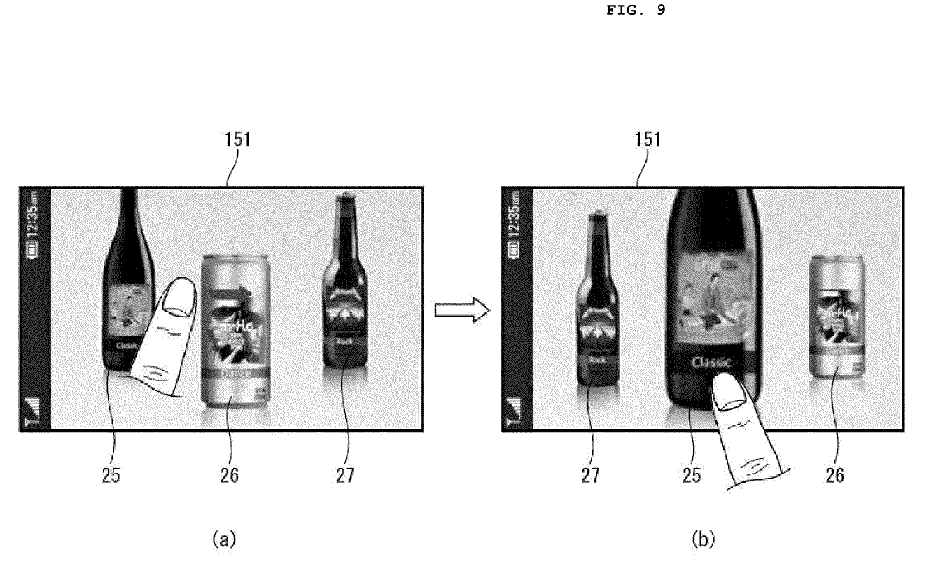

FIGS. 8 and 9 show exemplary images displayed when the step S100 shown in FIG. 6 is performed.

The plurality of objects may be represented as different graphics according to the different liquid attributes respectively corresponding thereto. The liquid attributes may include properties such as color, transparency and viscosity for classifying liquids physically or chemically.

For example, objects 20, 21, 22 and 23 shown in FIG. 8 may respectively include graphical elements which respectively represent attributes of different liquids such as coffee 20, beer 21, wine 22 and milk 23. Each of the objects 20, 21, 22 and 23 shown in FIG. 8 includes both the liquid corresponding thereto and a graphical element which represents a receptacle containing the liquid.

In the case of FIG. 8, the controller 180 may dynamically display the objects 20, 21, 22 and 23 to reflect the liquid attributes. Dynamic display of the objects 20, 21, 22 and 23 means representation of fluidity of the liquids corresponding to the objects 20, 21, 22 and 23, which will be described in detail later.

For example, objects 25, 26 and 27 shown in FIG. 9 may respectively include graphical elements which respectively represent attributes of different liquids such as bottled beer 25, can beer 26 and wine 27. The objects 25, 26 and 27 shown in FIG. 9 do not directly represent the liquids corresponding thereto and include graphical elements representing only receptacles containing the liquids.

The user may drag the display unit 151 with a finger to rotate the plurality of objects. For example, when the user drags the display unit 151 displaying the image of FIG. 8(a) to the left with a finger, the image of FIG. 8(b) is displayed. When the user drags the display unit 151 displaying the image of FIG. 8(b) to the left with a finger, the image of FIG. 8(c) is displayed.

The memory 160 store a plurality of music files which can be managed according to various applications. For example, the music playing application can manage the plurality of music files.

The plurality of music files may correspond to or include additional information such as genres, singers, titles and lyrics.

The plurality of objects may respectively correspond to recommended music in different genres. One of the plurality of objects may correspond to a plurality of recommended music files.

The memory 160 may store information on relationship between each of the plurality of objects and at lest one recommended music file corresponding thereto.

The controller 180 may display an indicator representing the genre of the at least recommended music file in such a manner that the indicator corresponds to a corresponding object. The indicator may include at least one of a text and an image.

Referring to FIG. 8, for example, the first object 20 is displayed to correspond to an indicator “coffee break 30.” The second object 21 is displayed to correspond to an indicator “PARTY 31.” The third object 22 is displayed to correspond to an indicator “Romantic 32.” The user can guess or recognize the genres of the recommended music respectively corresponding to the plurality objects through the indicators.

The controller 180 receives a signal for selecting one of the plurality of objects, which are displayed in the step S100, in step S110. The user can touch one of the plurality of objects to select a desired object.

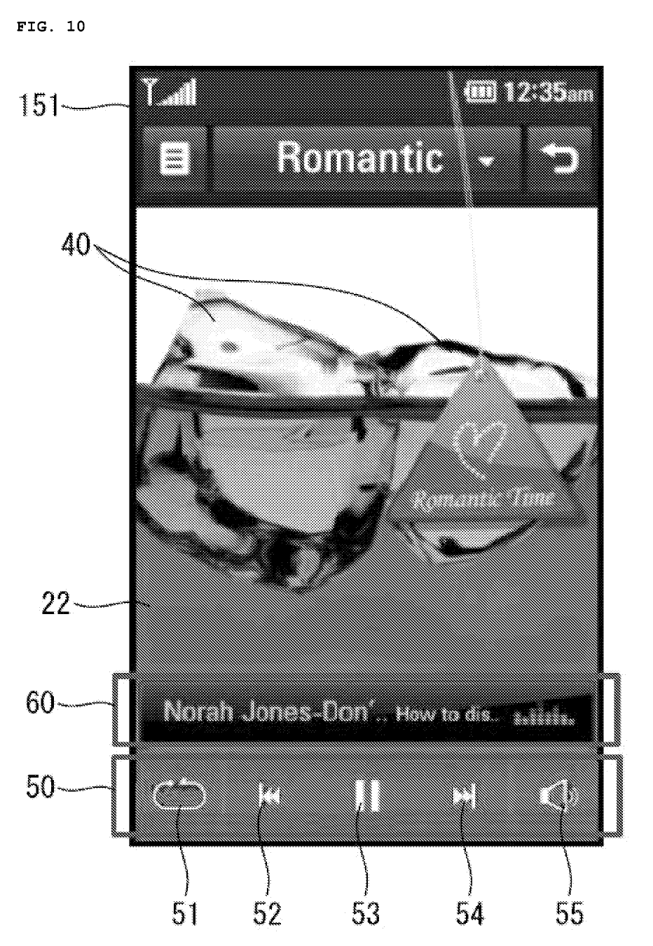

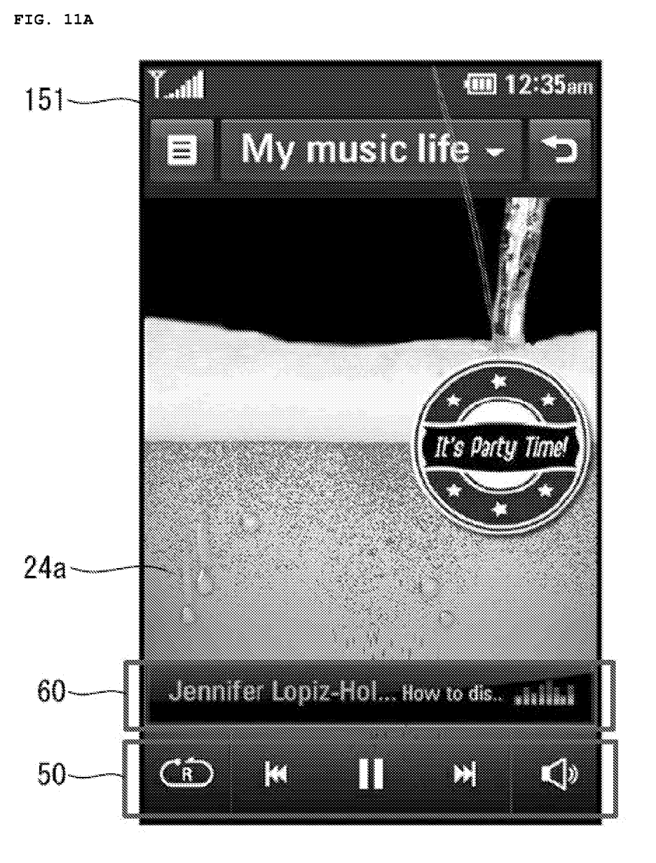

The controller 180 dynamically displays the selected object to reflect the liquid attribute corresponding to the selected object according to the selecting signal, which is received in the step S110, in step S120. FIG. 10 shows an exemplary image displayed when the step S130 shown in FIG. 6 is performed.

The controller 180 may change the image currently displayed on the display unit 151 to an image displaying a graphic corresponding to a music player 50 or display the graphic corresponding to the music player 50 on the display unit 151 when performing the step S130 according to the selecting signal received in the step S110. For example, if the third object 22 is selected, the image shown in FIG. 8 can be changed to the image displaying the music player 50, shown in FIG. 10.

The music player 50 may include a plurality of icons 51, 52, 53, 54 and 55 respectively corresponding to various functions.

Dynamically displaying the third object 22 means moving the third object 22 according to the liquid attribute corresponding to the third object 22. That is, the third object 22 does not remain still and a visual variation in the surface or inside of the third object is displayed. Furthermore, the dynamic display of the third object 22 may depend on a motion of the mobile terminal 100, which will be described later.

The controller 180 may display an object which previously corresponds to the selected third object 22 and has a liquid or solid attribute. Referring to FIG. 10, for example, when the currently displayed image is changed to the image including the music player 50, a solid 40 previously corresponding to the third object 22 may be displayed while the selected third object 22 is dynamically displayed. Further, the controller 180 may display an object having an attribute of another liquid previously corresponding to the third object 22.

The controller 180 may output the recommended music corresponding to the selected third object 22 in step S140. The step S140 may be automatically performed while the step S130 is carried out. Further, the step S140 may be executed according to a command of the user. For example, the step S140 may be performed when the user selects the icon 53 corresponding to a function of playing or stopping currently activated recommended music, which is shown in FIG. 10.

As described above, a plurality of recommended music files may correspond to the third object 22. That is, the third object 22 may be a category including a plurality of recommended music files.

The controller 180 may randomly output the plurality of recommended music files one by one or in a predetermined order when the plurality of recommended music files correspond to the third object 22.

In addition, the controller 180 may display an information region 60 which represents information on the recommended music corresponding to the selected third object 22. The information region 60 may include information on the title, singer, tone, genre, etc. of the recommended music.

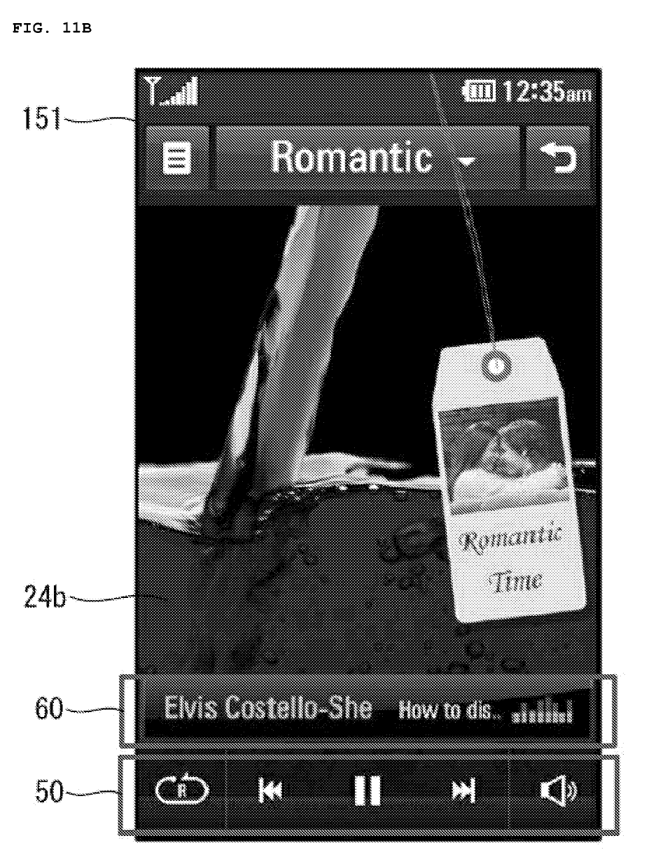

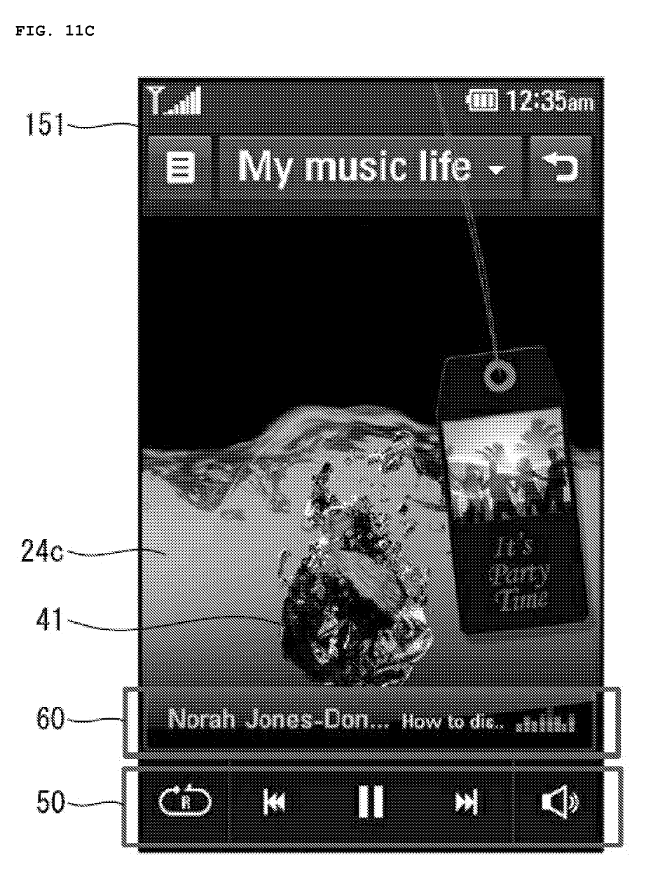

FIGS. 11A, 11B and 11C show another exemplary images displayed when the step S130 shown in FIG. 6 is performed. The images shown in FIGS. 11A, 11B and 11C may display selected objects 24a, 24b and 24c, a solid 41 corresponding to a selected object, the music player 50 and the information region 60, similarly to the image shown in FIG. 10.

As described above, the controller 180 may dynamically move the selected third object 22 in connection with a motion of the mobile terminal 100. The motion of the mobile terminal 100 may be sensed by a motion sensor of the sensing unit 140 and transferred to the controller 180.

The controller 180 may determine whether the motion of the mobile terminal 100 is sensed in step S150 and dynamically display the third object 22 to reflect the liquid attribute corresponding to the third object 22 and the sensed motion when the motion is sensed in step S160. For example, as the user tilts the mobile terminal 100, the third object 22 may be also tilted.

The controller 180 may display a new object, which is generated according to reaction of the third object 22 and an object 41 having a liquid or solid attribute and corresponding to the third object 22 to each other, on the display unit 151 in connection with the motion of the mobile terminal 100. For example, if the user shakes the mobile terminal 100, the third object 22 reacts to the object 41 having the attribute of ice to generate air bubbles around the object 41.

Further, the controller 180 may change a manner in which the selected object is displayed or generate and display a new object according to the liquid attribute corresponding to the selected object in connection with the motion of the mobile terminal 100.

For example, when the selected object corresponds to the second object 21 corresponding to the attribute of “beer,” the color of the second object 21 may be changed and “air bubbles” are generated according to the attribute of “beer” if the user shakes the mobile terminal 100.

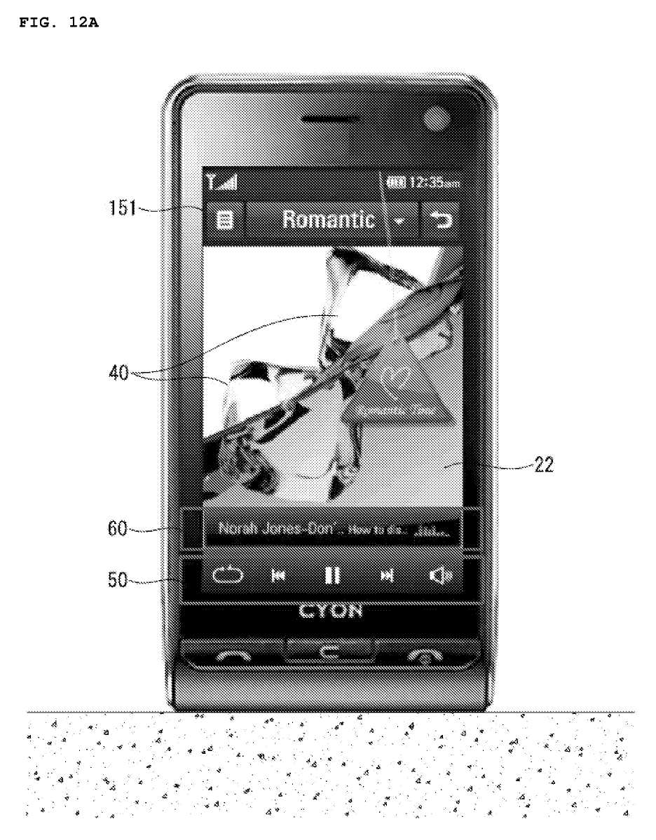

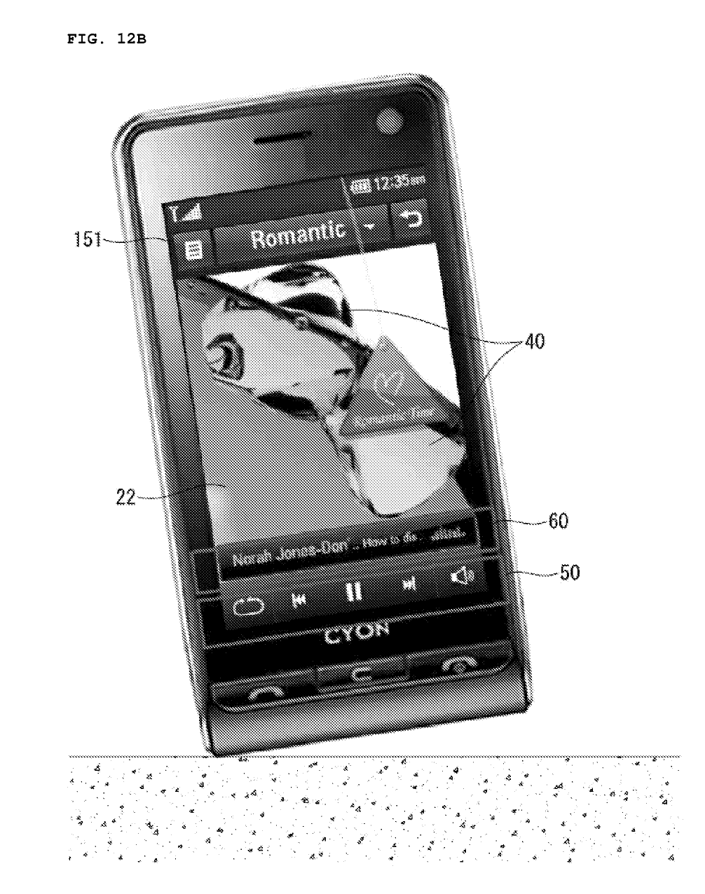

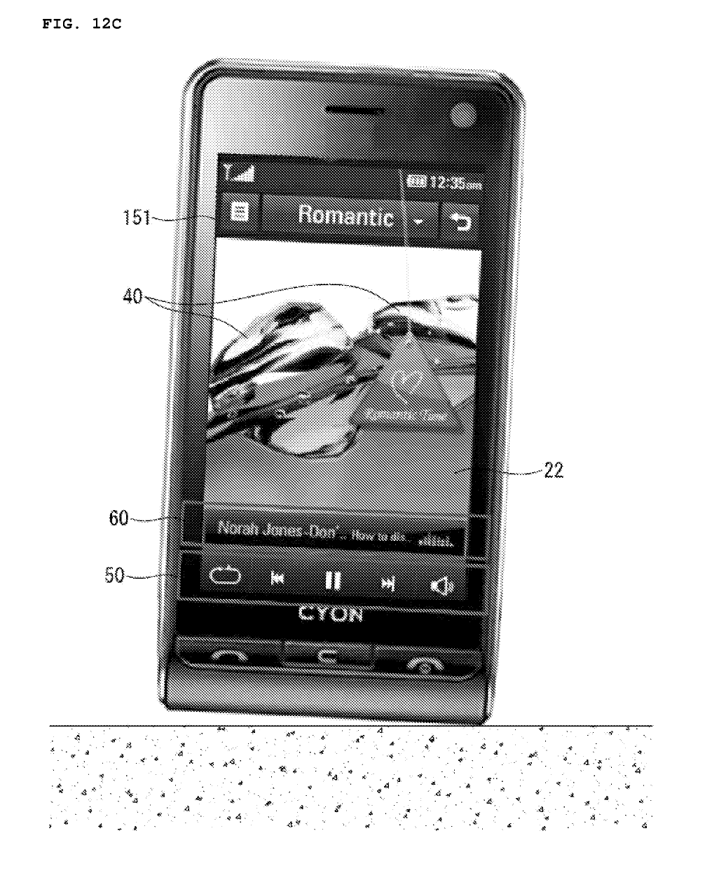

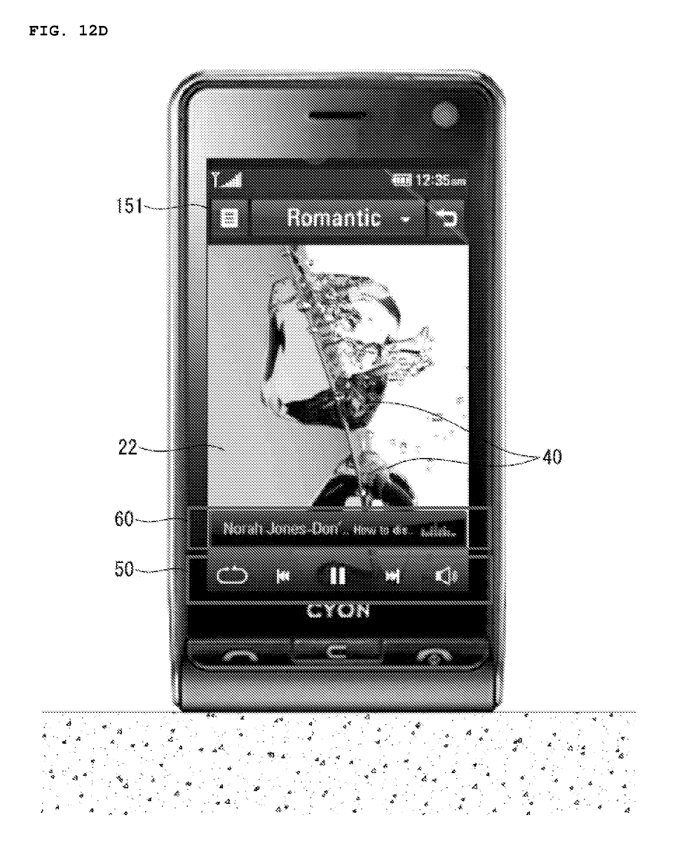

FIGS. 12A, 12B, 12C and 12D show exemplary images of an object, which are dynamically displayed in connection with a motion of the mobile terminal according to an embodiment of the present invention. FIGS. 12A, 12B, 12C and 12D show exemplary images of the selected object 22 and/or the object 40, which are dynamically changed when the absolute or relative position of the mobile terminal 100 is varied, for example, when the user moves, tilts or shakes the mobile terminal 100.

The above described method of providing recommended music in a mobile terminal according to the present invention can be written as computer programs and can be implemented in digital computers that execute the programs using a computer readable recording medium. The method of providing recommended music in a mobile terminal according to embodiments of the present invention can be executed through software. The software can include code segments that perform required tasks. Programs or code segments can also be stored in a processor readable medium and transmitted.

The computer readable recording medium includes all types of recording devices storing data readable by computer systems. Examples of the computer readable recording medium include ROM, RAM, CD-ROM, DVD±ROM, DVD-RAM, magnetic tapes, floppy disks, hard disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing recommended music in a mobile terminal, the method comprising the steps of:
displaying a plurality of objects respectively corresponding to at least one recommended music file and different liquid attributes;
selecting one of the plurality of objects;
dynamically displaying the selected object to reflect the liquid attribute corresponding to the selected object; and
outputting recommended music corresponding to the selected object.

2. The method of claim 1, wherein the plurality of objects respectively correspond to recommended music pieces in different genres.

3. The method of claim 1, wherein the liquid attributes include at least one of color, transparency and viscosity.

4. The method of claim 1, wherein the step of displaying the plurality of objects dynamically displays the plurality of objects to reflect the liquid attributes respectively corresponding to the plurality of objects.

5. The method of claim 1, wherein the step of displaying the plurality of objects displays an indicator indicating the genre of the at least one recommended music file corresponding to each of the plurality of objects in such a manner that the indicator corresponds to each of the plurality of object, and the indicator includes at least one of a text and an image.

6. The method of claim 1, wherein the step of dynamically displaying the selected object dynamically moves the selected object in connection with a motion of the mobile terminal, which is sensed by a motion sensor included in the mobile terminal.

7. The method of claim 1, wherein the step of dynamically displaying the selected object displays an object previously corresponding to the selected object and having a liquid or solid attribute.

8. The method of claim 7, wherein the step of dynamically displaying the selected object displays a new object, which is generated according to reaction of the selected object and the object having the liquid or solid attribute to each other, in connection with the motion of the mobile terminal, which is sensed by the motion sensor included in the mobile terminal.

9. The method of claim 1, wherein the step of outputting the recommended music outputs the at least one recommended music file corresponding to the selected object randomly or according to a predetermined order.

10. A mobile terminal comprising:
a display unit;
a memory configured to store at least one music file and a plurality of objects respectively corresponding to at least one recommended music piece belonging to the at least one music file and different liquid attributes; and
a controller configured to display the plurality of objects on the display unit, dynamically display an object selected from the plurality of objects to reflect the liquid attribute corresponding to the selected object and output recommended music corresponding to the selected object.

11. The mobile terminal of claim 10, wherein the plurality of objects respectively corresponds to recommended music in different genres.

12. The mobile terminal of claim 10, wherein the liquid attributes include at least one of color, transparency and viscosity.

13. The mobile terminal of claim 10, wherein the controller is configured to dynamically display the plurality of objects to reflect the liquid attributes respectively corresponding to the plurality of objects.

14. The mobile terminal of claim 10, wherein the controller is configured to display an indicator indicating the genre of the at least one recommended music file corresponding to each of the plurality of objects in such a manner that the indicator corresponds to each of the plurality of object, and the indicator includes at least one of a text and an image.

15. The mobile terminal of claim 10, further comprising a motion sensor capable of sensing a motion of the mobile terminal, wherein the controller is configured to dynamically move the selected object in connection with the motion of the mobile terminal, which is sensed by the motion sensor.

16. The mobile terminal of claim 10, wherein the controller is configured to display an object previously corresponding to the selected object and having a liquid or solid attribute on the display unit.

17. The mobile terminal of claim 16, further comprising a motion sensor capable of sensing a motion of the mobile terminal, wherein the controller is configured to display a new object, which is generated according to reaction of the selected object and the object having the liquid or solid attribute to each other, in connection with the motion of the mobile terminal, which is sensed by the motion sensor.

18. The mobile terminal of claim 10, wherein the controller is configured to output the at least one recommended music file corresponding to the selected object randomly or according to a predetermined order.
